(19) United States
(12) Patent Application Publication
(10) Pub. No.: US 2011/0087065 A1
(43) Pub. Date: Apr. 14, 2011

(54) Artificial Insemination Device

(76) Inventor: Chun-Min LIU, Jhongli City (TW)

(21) Appl. No.: 12/164,628

(22) Filed: Jun. 30, 2008

(51) Int. Cl. A61D 19/02

(52) U.S. Cl. 600/35

(57) ABSTRACT

An artificial insemination device includes a catheter, a widening tip connected to one end of the catheter for being introduced into the genital system of a female animal, and a check valve connected between the catheter and the widening tip and having a stopper supported on a spring between a first stop wall and a second stop wall for controlling the passage in the second stop wall for allowing the injected semen to pass out of the semen outlet in the first stop wall and prohibiting the injected semen from flowing backwards

### BACKGROUND OF THE INVENTION

1. Field of the Invention

The present invention relates to an artificial insemination device for breeding animals and more specifically, to a check valve used in an artificial insemination device to prohibit reverse flow of the injected semen.

2. Description of the Related Art

Artificial insemination is a process by which sperm are collected from the male, processed, stored and artificially introduced into the female reproductive tract for the purpose of conception. Artificial insemination has become one of the most important techniques for the genetic improvement of farm animals. Artificial insemination has the advantages of: opportunity to improve the entire herd's genetic merit; ability to check quality of semen before breeding; positive control of reproductive diseases; high conception rates; time-saving; better puppy survival rates; best way to breed a virgin bitch without possible harm to sire or dam.

Performing artificial insemination requires the use of an artificial insemination catheter. FIG. 1 illustrates a typical conventional artificial insemination catheter. According to this design, the artificial insemination catheter comprises a catheter A, a head (conical insert) B at one end, namely, the front end of the catheter A, and a tailpiece C at the other end, namely, the rear end of the catheter A. The tailpiece C has an injection hole C1 in communication with the inside space of the catheter A, and is provided with a movable plug C2 for sealing the injection hole C1. During application, the head (conical insert) B is inserted with the catheter A through the vulva into the reproductive tract. When a firm resistance is felt, the catheter is pulled slightly back to achieve a firm lock. Once the catheter is firmly locked in place, the semen is injected into the artificial insemination catheter through the injection hole C1 in the tailpiece C, allowing the uterine contractions to suck the semen out of the artificial catheter into uterus.

To avoid reverse flow of semen due to a pressure difference between the internal space of the genital organ and the atmosphere, the injection hole C1 must be sealed with the movable plug C2 immediately after injection of the semen. This artificial insemination technique is complicated. Further, this technique cannot fully eliminate reverse flow of semen during the operation, reducing conception rates and increasing the cost.

### SUMMARY OF THE INVENTION

The present invention has been accomplished under the circumstances in view. It is one object of the present invention to provide an artificial insemination device for breeding animals, which prevents reverse flow of the injected semen.

To achieve this and other objects of the present invention, the artificial insemination device is comprised of a catheter, a widening tip, and a check valve. The widening tip is connected to one end of the catheter for being introduced into the genital system of a female animal. The check valve is connected between the catheter and the widening tip for guiding an injected semen from the catheter toward the widening tip and the genital system of the female animal and prohibiting reverse flow of the injected semen. The check valve comprises a tubular valve body, a stopper, and an elastic member. The tubular valve body comprises a first stop wall transversely disposed at the front side and a second stop wall transversely disposed on the inside thereof and spaced from the first stop wall at a predetermined distance. The first stop wall has a center through hole axially for the passing of the injected semen out of the tubular valve body into the widening tip and the female animal's uterus. The second stop wall has a center through hole for the passing of the injected semen from the catheter toward the widening tip. The stopper is mounted inside the tubular valve body and movable between the first stop wall and the second stop wall to close/open the center through hole of the second stop wall. The stopper has a guide rod perpendicularly extending from the periphery thereof and inserted through the center through hole of the second stop wall to guide movement of the stopper relative to the second stop wall. The elastic member is mounted inside the tubular valve body and connected between the first stop wall and the stopper to impart a pressure to the stopper toward the second stop wall in forcing the stopper to close the center through hole of the second stop wall.

### BRIEF DESCRIPTION OF THE DRAWINGS

FIG. 1 is an elevational view of a conventional artificial insemination catheter.

FIG. 2 is an elevational view of an artificial insemination catheter according to the present invention.

FIG. 3 is an exploded view in section of the artificial insemination catheter according to the present invention.

FIG. 4 is a schematic sectional view of the present invention, showing an operation status of the artificial insemination catheter (I).

FIG. 5 is a schematic sectional view of the present invention, showing an operation status of the artificial insemination catheter (II).

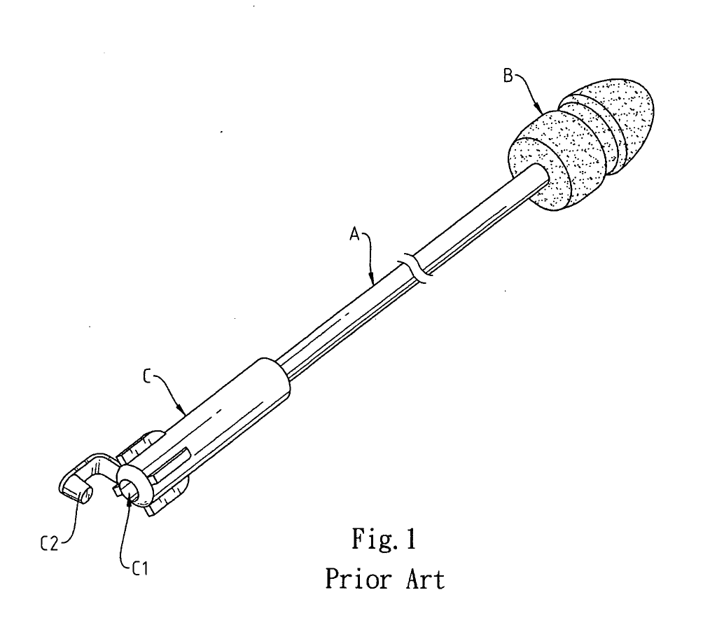

### DETAILED DESCRIPTION OF THE PREFERRED EMBODIMENT

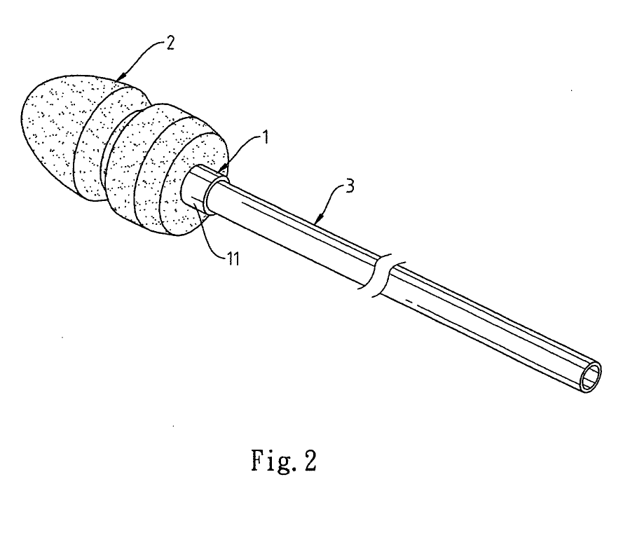

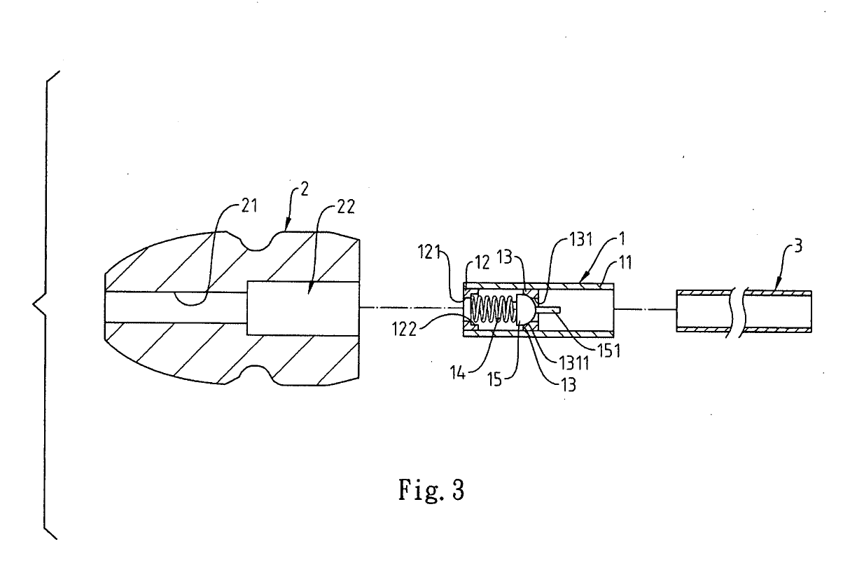

Referring to FIGS. 2 and 3, an artificial insemination device in accordance with the present invention is shown comprised of a check valve 1, a widening tip 2, and a catheter 3.

The check valve 1 is comprised of a tubular valve body 11, an elastic member 14, and a stopper 15. The tubular valve body 11 has a first stop wall 12 transversely disposed at the front side, and a second stop wall 13 transversely disposed on the inside and spaced from the first stop wall 12 at a predetermined distance. The first stop wall 12 has a circular groove 122 formed on the back side and facing the second stop wall 13, and a center through hole 121 axially extending through the center of the circular groove 122 for the passing of the injected semen out of the artificial insemination catheter into the female animal's uterus. The second stop wall 13 has a center through hole 131 for the passing of the injected semen from the catheter 3 toward the widening tip 2. The center through hole 131 has a tapered orifice 1311 that has a diameter gradually increasing in direction from the second stop wall 13 toward the first stop wall 12. The elastic member 14 is mounted inside the tubular valve body 11 between the first stop wall 12 and the second stop wall 13, having its front end positioned in the circular recess 122 of the first stop wall 1 and its rear end stopped against the stopper 15. The stopper 15 is a semispherical member movably mounted in the tubular valve body 11 and supported on the rear end of the elastic member 14, having a guide rod 151 perpendicularly extending from the center of the periphery and inserted through the center through hole 131 of the second stop wall 13. Normally, the elastic member 14 imparts a pressure to the stopper 15, forcing the periphery of the stopper 15 into close contact with the tapered orifice 1311 of the center through hole 131 of the second stop wall 13 to block the passage of the center through hole 131 of the second stop wall 13.

The widening tip 2 has a stepped through hole formed of a front section 21 of relatively smaller diameter and a rear section 22 of relatively greater diameter.

The catheter 3 is a flexible tube.

During installation of the present invention, the check valve 1 is inserted with its front end into the rear section 22 of the stepped through hole of the widening tip 2, and the catheter 3 is connected to the rear end is connected to the rear end of the check valve 1.

Further, the widening tip 2 can be made of rubber or a foam material. The elastic member 14 can be spring, for example, compression spring.

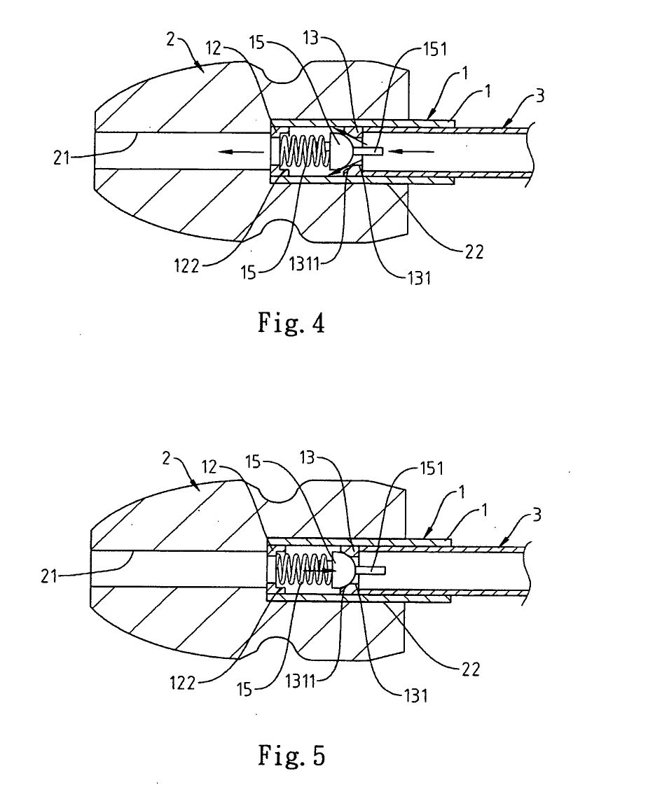

Referring to FIGS. 4 and 5, the widening tip 2 is introduced into the genital system of the female animal, and then the collected semen is injected into the catheter 3. At this time, the semen is forced to push the stopper 15 against the elastic member 14, moving the stopper 15 forwards and away from the tapered orifice 1311 so that the injected semen flow through the center through hole 131 of the second stop wall 13 and the center through hole 121 of the first stop wall 12 into the female animal's uterus. When the injection is stopped, the elastic member 14 immediately returns the stopper 15 to block the center through hole 131 of the second stop wall 13, prohibiting reverse flow of the injected semen.

During forward/backward displacement of the stopper 15, the guide rod 151 of the stopper 15 is moved in the center through hole 131 of the second stop wall 13, keeping movement of the stopper 15 in course.

In general, the invention uses the elastic member 14 in the check valve 1 to support the stopper 15. During injection of a semen, the stopper 15 is moved away from the tapered orifice 1311 for allowing the injected semen to pass out of the artificial semination device into the female animal's uterus. Immediately after the injection action is stopped, the elastic member 14 returns the stopper 15 to block the center through hole 131 of the second stop wall 13, preventing a reverse flow of the injected semen.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An artificial insemination device for breeding animals, comprising: a catheter; a widening tip connected to one end of said catheter for being introduced into the genital system of a female animal; and a check valve connected between said catheter and said widening tip for guiding an injected semen from said catheter toward said widening tip and the genital system of the female animal and prohibiting reverse flow of the injected semen; wherein said check valve comprises:
a tubular valve body, said tubular valve body comprising a first stop wall transversely disposed at a front side thereof and a second stop wall transversely disposed on the inside thereof and spaced from said first stop wall at a predetermined distance, said first stop wall having a center through hole axially extending through front and back sides thereof for the passing of the injected semen out of said tubular valve body into said widening tip and the female animal's uterus, said second stop wall having a center through hole for the passing of the injected semen from said catheter toward said widening tip;
a stopper mounted inside said tubular valve body and movable between said first stop wall and said second stop wall to close/open the center through hole of said second stop wall, said stopper having a guide rod perpendicularly extending from the periphery thereof and inserted through the center through hole of said second stop wall to guide movement of said stopper relative to said second stop wall; and
an elastic member mounted inside said tubular valve body and connected between said first stop wall and said stopper to impart a pressure to said stopper toward said second stop wall in forcing said stopper to close the center through hole of said second stop wall.

2. The artificial insemination device as claimed in claim 1, wherein said first stop wall has an annular groove formed on the back side thereof around the center through hole of said first stop wall and facing said second stop wall.

3. The artificial insemination device as claimed in claim 1, wherein the center through hole of said second stop wall has a tapered orifice.

4. The artificial insemination device as claimed in claim 1, wherein said stopper is shaped like a semispherical shell.

5. The artificial insemination device as claimed in claim 1, wherein said stopper is made of rubber.

6. The artificial insemination device as claimed in claim 1, wherein said stopper is made of a foam material.

7. The artificial insemination device as claimed in claim 1, wherein said widening tip has a stepped through hole extending through front and rear sides thereof for the positioning of said check valve.

8. The artificial insemination device as claimed in claim 1, wherein said catheter is made of a flexible material.

9. The artificial insemination device as claimed in claim 1, wherein said elastic member is a compression spring.
